(19) United States
(12) Patent Application Publication
(10) Pub. No.: US 2007/0227341 A1
(43) Pub. Date: Oct. 4, 2007

(54) Sound card particularly for connection between a computer and a musical instrument

(75) Inventor: Enrico Iori, Modena (IT)

Correspondence Address: MODIANO & ASSOCIATI, Via Meravigli, 16, MILAN, 20123, omitted

(73) Assignee: IK MULTIMEDIA PRODUCTION SRL

(21) Appl. No.: 11/716,647

(22) Filed: Mar. 12, 2007

(30) Foreign Application Priority Data
Mar. 29, 2006 (IT) MO2006A000109

(51) Int. Cl. G10H 7/00

(52) U.S. Cl. 84/645

(57) ABSTRACT

A sound card particularly for connection between a musical instrument and a computer, having an integrated first cable for connection to the musical instrument and a second cable for connection to the computer.

The present invention relates to a sound card particularly for connecting a musical instrument to a computer.

More particularly, the invention relates to a sound card for connection between a musical instrument, such as a guitar, bass, microphone, keyboard, et cetera, and a computer, so as to process the signal from analog to digital so that it can be recorded and/or processed by the computer by means of appropriate software, or by the computer to appropriate amplified loudspeakers and/or headphones.

### BACKGROUND OF THE INVENTION

As is known, sound cards are commercially available which can be connected to a computer by using the PC slot or the USB or FireWire input of the computer. These cards allow to process the analog signal that originates from a musical instrument into a digital signal so that it can be recorded and/or processed by the computer.

Generally, in the case of sound cards with a USB or FireWire connection, said cards are constituted generally by an external computer with female audio connectors and female USB connectors, and therefore the user has to physically connect the musical instrument by means of an appropriate audio cable to this card and subsequently connect the card to the computer by means of a USB cable.

Therefore, the user is forced to connect two separate cables, one between the sound card and the musical instrument and the other between said sound card and the computer.

Although these operations are relatively simple, they entail an expenditure of time and in any case are “technical” operations which are often not welcomed by musicians who are the main users of sound cards of this kind.

### SUMMARY OF THE INVENTION

The aim of the present invention is to provide a sound card particularly for connection between a musical instrument and a computer which allows to eliminate the need to have loose cables to be connected in each instance to the sound card at one end and, at least as far as this context is concerned, the computer and the musical instrument.

Within this aim, an object of the present invention is to provide a sound card particularly for connection between a musical instrument and a computer which simplifies considerably the operations for connecting the sound card to the musical instrument and to the computer, thus making the card attractive even for people who are not experts in the field.

Another object of the present invention is to provide a sound card which is highly reliable, relatively simple to provide and at competitive costs.

This aim and these and other objects, which will become better apparent hereinafter, are achieved by a sound card, particularly for connection between a musical instrument and a computer, characterized in that said sound card integrates a first cable for connection to said musical instrument and a second cable for connection to said computer.

### BRIEF DESCRIPTION OF THE DRAWINGS

Further characteristics and advantages of the invention will become better apparent from the following detailed description of a preferred but not exclusive embodiment of the sound card according to the invention, illustrated by way of non-limiting example in the accompanying drawings, wherein:

FIG. 1 is a view of the sound card according to the invention, which can be connected to a musical instrument at one end and to a computer at the other end;

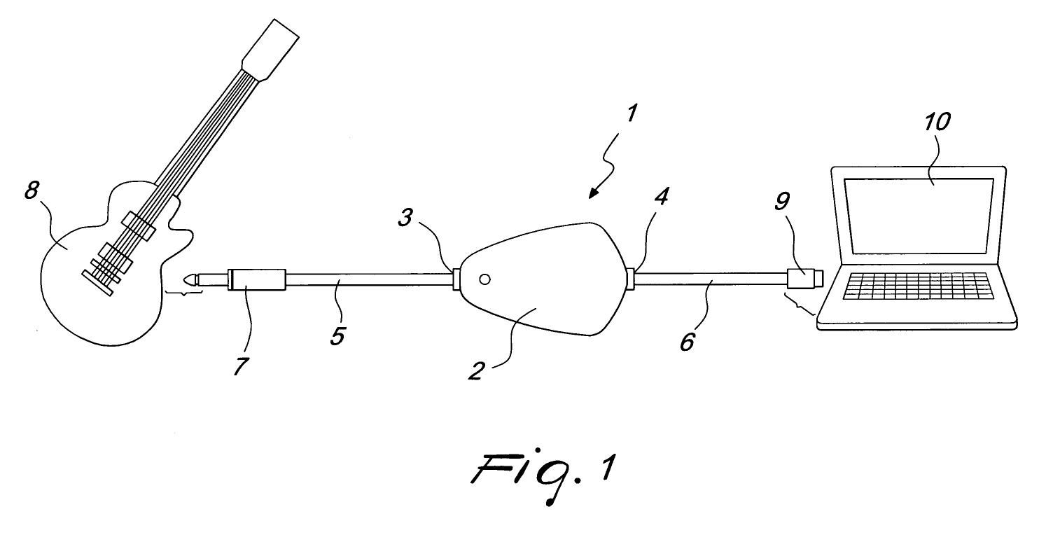

FIG. 2 is a block diagram of the sound card according to the present invention.

### DESCRIPTION OF THE PREFERRED EMBODIMENTS

With reference to the figures, a sound card according to the invention, generally designated by the reference numeral 1, comprises a containment body 2, which is suitable to accommodate the card which provides a conversion of the sound signal that arrives from a musical instrument from analog to digital, so that said signal can be processed by a computer. The containment body 2 is provided with two openings 3 and 4 at the respective ends, through which a first cable 5 is connected directly to the sound card inside the container 2, and a second cable 6, which is also connected to the sound card inside the container 2.

The first cable 5 is provided with a connector 7 which allows direct connection to a musical instrument 8, while the second cable 6 is provided with a USB connector 9, or another type of connector, which allows direct connection to a computer 10.

Substantially, therefore, the sound card 1 has the appearance of a compact body with the connecting cables 5 and 6 directly connected to the body 2 which accommodates the sound card, so that the user only has to connect the connector 7 to the musical instrument 8 and the connector 9 to the computer 10, without having to worry about connecting the cables 5 and 6 to the sound card as well.

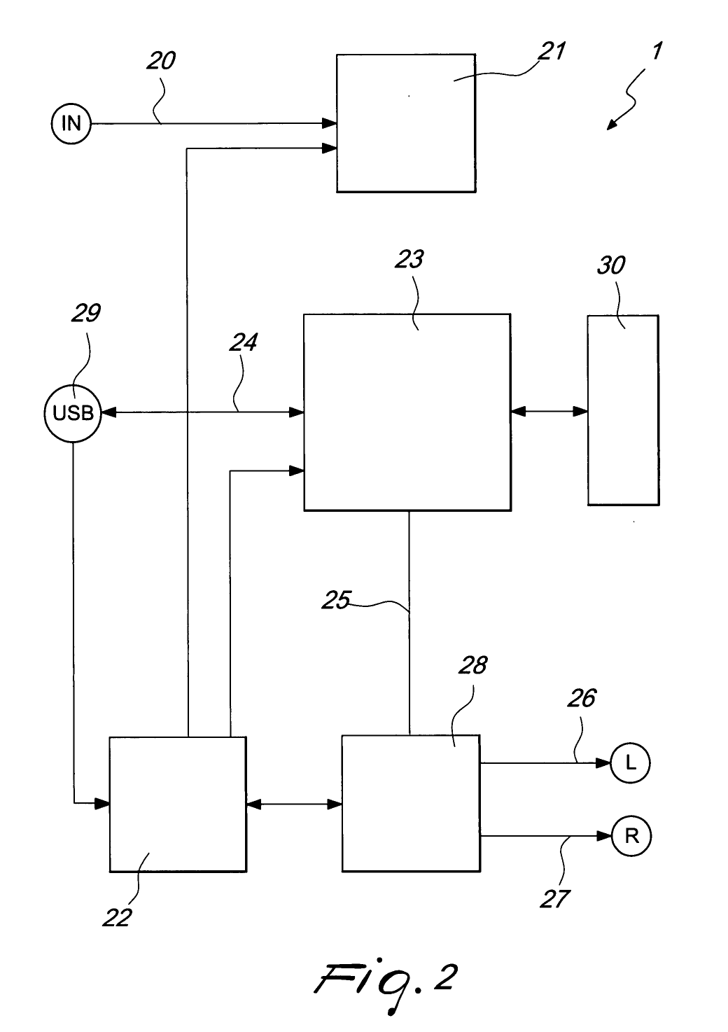

The block diagram of the sound card according to the invention is shown in FIG. 2.

Said figure shows that an analog signal 20 that arrives from a musical instrument, such as a guitar or the like, is sent in input to a buffer 21, which is also powered by a power supply 22. The analog signal is sent from the buffer 21 to a processor 23, where analog-to-digital conversion is performed and the resulting signal is sent over a USB data bus 24. At this point the signal enters the computer 10, where it is processed appropriately by the software that is present in the computer.

From the computer 10, the signal is sent into the processor 23, which converts it back to analog and the resulting signal, designated by the reference numeral 25, is then sent to outputs 26 and 27 of the headphones after amplification by way of amplifier means 28.

The power supply 22 draws power directly from the USB 29 and reconditions it appropriately in order to supply power to the buffer 21, the processor 23 and the amplifier means 28.

Finally, there are controls for adjusting the volume and status LEDs, generally designated by the reference numeral 30 in FIG. 2.

In practice it has been found that the sound card according to the invention fully achieves the intended aim and objects, since it allows to spare the user from having to connect the cables between the instrument and the card and between the card and the computer also to the card itself, said card being already provided with integrated cables.

The invention thus conceived is susceptible of numerous modifications and variations, all of which are within the scope of the appended claims; all the details may further be replaced with other technically equivalent elements. For example, it is obvious that the USB connection can be replaced with a connection of the FireWire type or by another suitable bus.

In practice, the materials used, as well as the contingent shapes and dimensions, may be any according to requirements and to the state of the art.

The disclosures in Italian Patent Application No. M02006A000109 from which this application claims priority are incorporated herein by reference.

What is claimed is:

1. A sound card, particularly for connection between a musical instrument and a computer, wherein said sound card integrates a first cable for connection to said musical instrument and a second cable for connection to said computer.

2. The sound card of claim 1, wherein said first cable is provided at the free end with a connector for connection to said musical instrument.

3. The sound card of claim 1, wherein said second cable is provided at the free end with a connector for connection to said computer.

4. The sound card of claim 3, wherein said connector of said second cable is a USB, FireWire or other connector which can be used on a computer.

5. The sound card of claim 1, comprising a body which accommodates the circuitry of the sound card, said body being provided with a first opening and a second opening which are respectively suitable to allow the passage of said first cable and of said second cable.

6. The sound card of claim 1, comprising a processor which is suitable to receive in input an analog signal which arrives from said musical instrument and to digitize it to send said signal to a USB, FireWire or other suitable bus.

7. The sound card of claim 6, comprising a buffer which is interposed between said processor and said musical instrument, said buffer receiving in input said analog signal of said musical instrument.

8. The sound card of claim 7, comprising amplifier means which are suitable to amplify an analog signal emitted by said processor and to send it to an analog output to which headphones can be connected.

9. The sound card of claim 8, comprising power supply means which are suitable to draw power from a USB, FireWire or other suitable bus and to supply said buffer, said processor and said amplifier means.
